(19) United States
(12) Patent Application Publication
(10) Pub. No.: US 2025/0148148 A1
(43) Pub. Date: May 8, 2025

(54) ENHANCED PERFORMANCE MODEL MATCHING, AUGMENTATION AND PREDICTION

(71) Applicant: NUOVO PIGNONE TECNOLOGIE -S.R.L., Firenze (IT)

(72) Inventors: Ernesto Heliodor ESCOBEDO HERNANDEZ, Querétaro (MX); Giampaolo GABBI, Firenze (IT)

(21) Appl. No.: 18/838,092

(22) PCT Filed: Feb. 17, 2023
(86) PCT No.: PCT/EP2023/025076

§ 371 Date: Aug. 13, 2024

(30) Foreign Application Priority Data
Feb. 21, 2022 (IT) 102022000003167

(51) Int. Cl. G06F 30/15; G06F 119/02

(52) U.S. Cl. CPC G06F 30/15; G06F 2119/02

(57) ABSTRACT

A simulation method for simulating the operation of a gas turbine (111) is disclosed. The method comprises a global search procedure and an iterative local search procedure, to calculate parameters to simulate the operation of the gas turbine (111). The output parameters can also be used for monitoring the operation of the gas turbine (111) and planning the maintenance. Also disclosed is a characterization system, for characterizing and simulating the operation of a gas turbine (111).

### TECHNICAL FIELD

The present disclosure concerns an enhanced performance model matching, augmentation, and prediction, for simulating and predicting the operation of an engine, such as a gas turbine, and the like, for improving the monitoring of the engine.

### BACKGROUND ART

As it is known, a gas turbine (also known as “Digital Twin”) is a rotary machine suitable to transform chemical energy into mechanical energy. It is a machine usually used to generate electrical energy or drive compressors.

In general, a gas turbine comprises a combustion chamber provided with nozzles for injecting the fuel to be burned. The fuel is intended to be burned inside the combustion chamber. Then, after the burning, the hot exhaust gases exit the combustion chamber to move an impeller attached to a shaft, thus providing mechanical work to be used for any necessity, as mentioned above.

Modern gas turbines are very complex machines and therefore, in order to control the operation and optimize their consumption, they are equipped with many sensors, arranged for detecting in collecting data concerning their operation. These data are then collected for allowing the realization of dashboards, for operators to check in real-time the operation of the gas turbine. In addition, modern gas turbines are also equipped with processing systems, intended to process the data collected by the sensors to realize additional processing and optimize the operation of the gas turbine.

However, often the control and the monitoring of the operation of a system is complex and therefore not always accurate. Also, still for the complexity of the engine, several operating parameters cannot be measured, and therefore cannot be properly controlled. It is, therefore, not always possible to carry out a constant and accurate diagnosis of the gas turbine, or the engine in general. This implies an approximation in the planning of the maintenance as well as the prediction of possible failures, which turn out in an increase in the overall operating expenditures (OPEX) for managing the engine.

Accordingly, a method for simulating and predicting the behavior of several operating parameters of the gas turbine will be highly welcomed in the technology. More in general, it would be desirable to provide a method, and the relevant system implementing the same, for predicting with high precision the operation of the engine, associating patterns of values of correlated operating parameters.

### SUMMARY

The present disclosure concerns a performance characterization of a gas turbine, which can be used to at least predict unmeasured (or unmeasurable) parameters, track engine performance, and predict engine behavior under virtual states/what if scenarios using detailed physical models.

The invention uses data from an automated system, capable of obtaining operational data from on-site monitoring infrastructure (the gas turbine). The sensor data is matched with a physics-based model, which is optimized with a novel solver, which is a program for processing data. The solver executes a local and global search to find the model parameters that will resemble most closely the sensor measurements at site. The model parameters are then used to obtain synthetic parameters, which are either unmeasured quantities or simulations at other conditions. These synthetic parameters can then be used to track engine performance (e.g., ISO Power) or become synthetic/virtual sensors or a digital redundancy for physical sensors.

Specifically, the solution encompasses a bundle of model-based methodologies for characterizing and monitoring the performance of fielded gas turbines. Since the methodologies are based on high fidelity models, they can also be leveraged to predict the behavior of the gas turbine capabilities under different environmental and operation conditions. The method and system object of the present disclosure can further be offered as services to customers interested in automated/digital gas turbine performance monitoring, advisories and simulations.

Therefore, an enhanced performance model matching, augmentation, and prediction as defined in claim 1 forms the specific object of the present invention.

Preferred embodiments are defined in the dependent claims.

### BRIEF DESCRIPTION OF THE DRAWINGS

A more complete appreciation of the disclosed embodiments of the invention and many of the attendant advantages thereof will be readily obtained as the same becomes better understood by reference to the following detailed description when considered in connection with the accompanying drawings, wherein:

FIG. 1 illustrates a block diagram of a system for simulating the operation of a gas turbine according to a first embodiment;

FIG. 2 illustrates a flowchart of the global search procedure of the simulation method, according to a first embodiment;

FIG. 3 illustrates a more detailed flowchart of the global search procedure of the simulation method, according to a first embodiment;

FIG. 4 illustrates a flowchart of the local search procedure of the simulation method, according to a first embodiment;

FIG. 5 illustrates a first implementation of the simulation method of the present disclosure; and

FIG. 6 illustrates a second implementation of the simulation method of the present disclosure.

### DETAILED DESCRIPTION OF EMBODIMENTS

In the various figures, similar parts will be indicated by the same reference numbers.

The gas turbines are complex systems, whose operation and control are technically challenging, in view of the required optimizations required, e.g. for reducing the pollution, as well as to plan proper maintenance reducing any risk of damages or misfunction. The operation of a gas turbine can be characterized by a large number of physical parameters, that have to be constantly sensed and monitored to properly control and evaluate the operation of the gas turbine. According to one aspect, the present subject matter is directed to an algorithm capable of simulating with high precision, the operation of a gas turbine, characterized by the above large set of parameters, determining the time evolution and change of the parameters, through a self-updating model, capable of adapting to (and predicting as well) the behavior of the gas turbine, so as to plan any possible service or maintenance, as well to better drive the operation of the gas turbine.

The solution then concerns a method intended to obtain and use both real as well as synthetic parameters, which is applicable to simulate different operating conditions of a complex system like a gas turbine or an engine in general, to optimize its maintenance and operations.

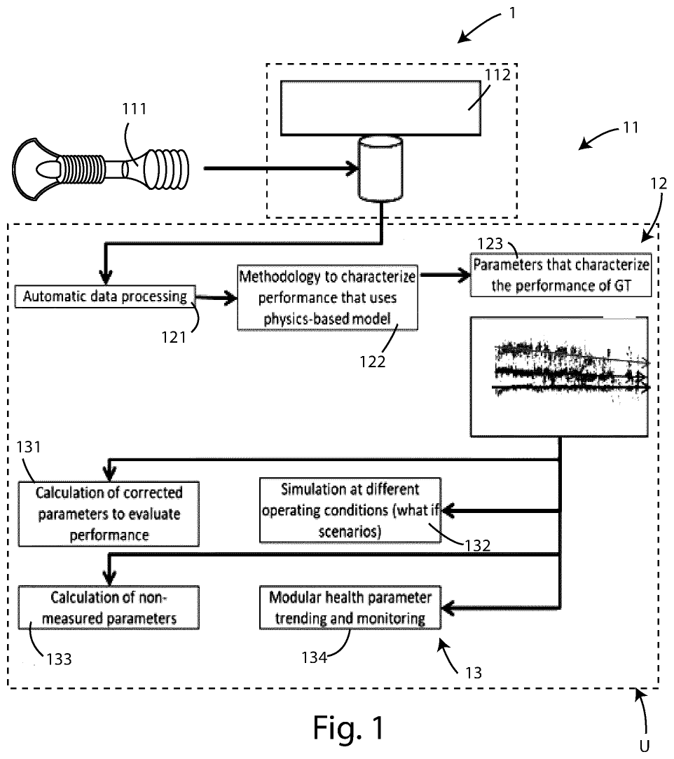

Referring now to the drawings, FIG. 1 shows a block diagram of the overall characterization system 1 for characterizing and simulating the operation of a gas turbine (or any other complex machine or engine), which can be ideally divided into two main parts, namely an infrastructure section 11, and a processing unit U, comprising, in its turn, an automatic performance characterization section 12, and a delivery service section 13.

The infrastructure section 11 comprises the gas turbine 111 to be controlled, which is equipped with sensors to detect operating parameters, whose number is indicated with M, such as the temperature of the different parts of the gas turbine 111, the pressure of the gas or of the exhaust gases, the rotary speed of the rotor, the temperature of the combustor, the pressure of the compressor, the temperature of the compressor, and the like.

With the word “parameters” is intended, in general, not only pressure, temperature or any other measurable parameter that can be detected by the sensors the gas turbine 111 is equipped with, but also derived variables and data that cannot be directly measured. The parameters can be taken at different time frames, such as on a daily basis, on a weekly basis, or on a monthly basis, for example. Each set of parameters is sensed at a certain time forms record (it can be visualized with a vector). Usually, the number of parameters and data detected from a gas turbine can range from 30 to 50, although in other embodiments or indifferent gas turbines, a different number of parameters and data can be detected.

Considering data spanning for a predefined time interval, a number N of records are collected, gathering a number of N×M as input.

The infrastructure section 11 also comprises a data recording unit 112, which is wired connected to sensors of the gas turbine 111. The data recording unit 112 collects the data and the signals of the sensors, which are sampled and analog to digital converted. An example of data collected are the efficiency, the flow capacities, and the discharge coefficients.

In some embodiment, the data recording unit 112 can be a computer or a cloud computing system or mainframe, capable of storing data performing calculations ad running software.

The data recording unit 112 receives data from gas turbine 111 installed sensors, which are transmitted via an infrastructure.

The processing unit U can also be a computer or a or cloud computing system or mainframe and it can be the same computer or processing means of the data recording unit 112.

The automatic performance characterization section 12 of the processing unit U comprises several computer-implemented modules, which implement an automatic data processing module 121. In particular, due to connection interruptions, sensor failures or other unpredictable situations, the data may have gaps, delays and in general non-ideal behavior that may or may not be detected from existing control systems or data infrastructure. The characterization system 1 can run programs based on methods for automatic data processing with the capability to deal with remaining data corruptions, i.e. outlier detection, filtering, data imputation, resampling, and the like, to ensure that the data is suitable for analysis. This data-preprocessing is carried out by the automatic data processing module 121.

The automatic performance characterization section 12 processes the data or the pre-processed data received by automatic data processing module 121, by a physics-based model 122. The module implements a methodology to characterize the performance that uses the physics-based model to generate output parameters 123 that characterize the performance of the gas turbine 111.

In particular, after going through the preprocessing step as mentioned above executed by the automatic data processing module 121, the data is fed to the physics-based model 122, which uses as inputs the field data and the outputs of a physics-based solver model for the gas turbine 111 performance. The processing method processes parameters that characterize the operation of the gas turbine 111. In some embodiments, the method, in general terms, compares the field measured data M and the modeled data and the comparisons are used to obtain the parameters S to simulate the gas turbine 111, which are schematically represented by the output parameters in step 123.

In other embodiment of the method implemented in the physics-based model 122, the method also adjusts the model parameters H to provide outputs that coincide with field measured data. In this case, the adjusted model parameters H are considered part of the parameters for obtaining the subsequent iterations.

Once the gas turbine 111 has been characterized with the parameters obtained and possibly shown in the output parameters 123, these parameters can be input in the model to simulate engine capabilities at different conditions, as schematized by delivery service section 13, which includes additional functional modules that process the simulated parameters S through the model parameters Hₘ, capable to represent the gas turbine 111. In particular, one possible application for the simulation is the calculation of corrected parameters (module 131) representative of the performance of the gas turbine 111. In particular, in gas turbines 111, the ambient and operating conditions remarkably affect the performance of the engine, so in order to detect degradation (loss of power, fuel increase, etc.), the engine outputs should be corrected to a set of standard conditions (i.e. ISO conditions) to be able to compare the corrected performance parameters as shown in the evaluation performance module 131 over time.

Another application is to calculate non-measured (or non-measurable) parameters (module 133), for example, in the case of a gas turbine 111, the power output, and/or other parameters that may not be measured directly but inferred from the simulation model. In this case, the output parameters 123 can be used with the model to simulate the non-measured (non-measurable) parameters.

Another application is to track the trend and monitor of the modular parameters as indicated in module 134, to track the performance of specific components of the gas turbine 111. The applications mentioned are examples of services that can be offered to monitor, trend, and make expert advisory in the event of degradation or engine underperformance.

The characterization in the embodiment is very complete and it can be carried out also for fleets of gas turbines 111, which require also fleet optimization.

The automatic data processing module 121 and the physics-based model 122 of the gas turbine 111 are implemented in computers also in the form of a software program. The output parameters 123 can be also plotted and their statistics appreciated and used to monitor and control the gas turbine 111.

As mentioned above, the data gathered from the gas turbine 111 are detected and processed to realize the simulation of the gas turbine 111 (or the engine in general) itself. This operation is made by the solver, which is implemented in the physics-based model 122.

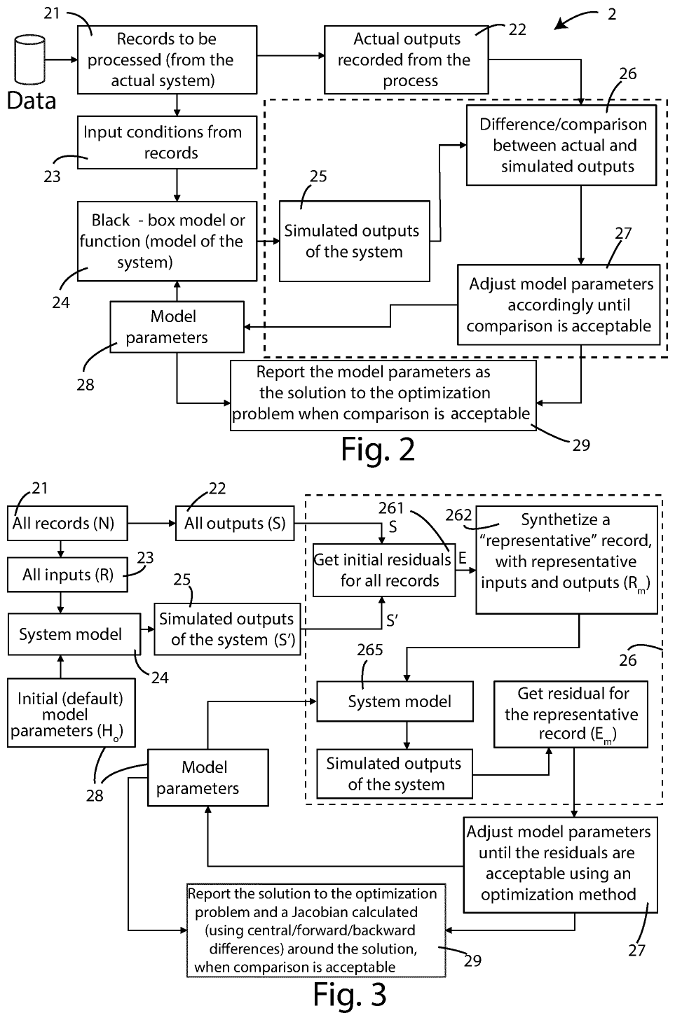

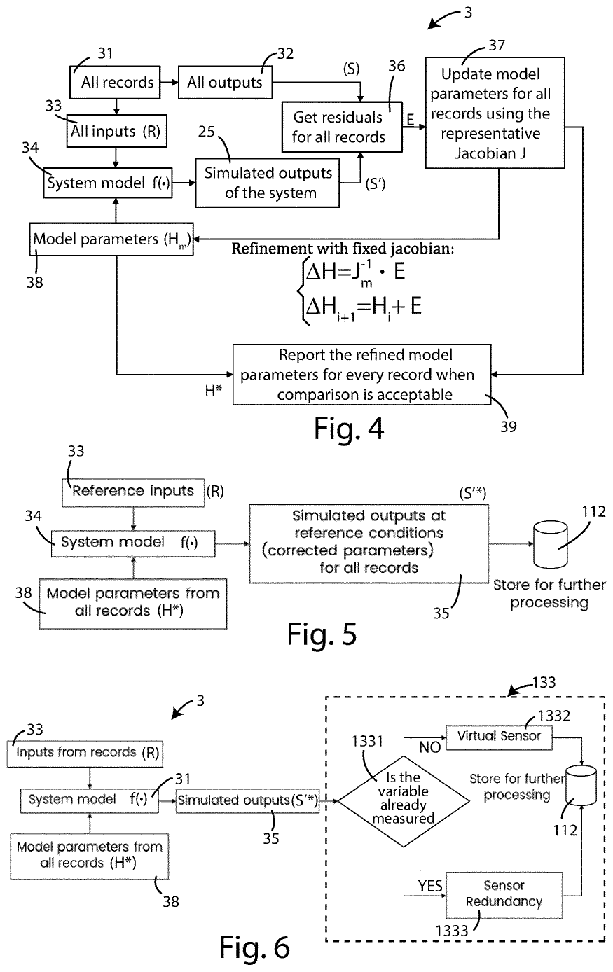

In the following FIG. 2, FIG. 3, and FIG. 4 a global search procedure 2 and a local search procedure 3 are disclosed, then it is possible to simulate the output parameters of the operation of the gas turbine 111, to monitor to derive data and/or unmeasured or unmeasurable parameters of the engine 111 itself.

In this disclosure, a batch of data is processed together and the search for a good initial solution for all the batches is done just one time by the global search procedure 2, and then the local search procedure 3 refines the initial solution for every point (which is then called local search). On continuous and smooth functions, finding a good starting point is very useful, because if the point is sufficiently close, and the Jacobian has been already computed around this starting point, the local search can be guided without recalculating the Jacobian (namely it is kept constant), as better disclosed below.

Referring now in particular to FIG. 2, a general flowchart is illustrated representing the operation of the global search procedure 2 of the solver method according to the present disclosure. Specifically, the flowchart shown in FIG. 2 illustrates the steps of the solver method, capable of underlying the problem solved by the same. In particular, shown a flowchart of the optimization problem is shown, which describes how to make a simulation as close as possible to the real system (the engine or the gas turbine) by changing input parameters to the simulation until the measured parameters taken from the gas turbine 111 matches with the simulated parameters.

The solver method underlying the global search procedure 2 solves an optimization problem, where the solution varies slowly with time, while also minimizing function evaluations. This solution is also adapted to black-box models that don't have a definite or explicit formula (which is the case for the cycle deck or models obtained through machine learning techniques, for instance).

In addition, in gas turbine 111 the degradation process is usually not a fast process, namely the degradation of the gas turbine operation requires several weeks. Therefore it is expected that, if data are processed within a temporal locality (i.e., one week, one day, one month), even if the amount of data is large (i.e., of the order of thousands of records), the solution for each individual record would tend, overall, to have similar solutions. When a single point (individuated by the values of a record) goes to the optimization process, usually it is possible to start from an initial solution, which might even be far from the real solution.

In general terms, the method according to the present disclosure is particularly useful in case of function evaluations are expensive.

In particular, the solver synthesizes a fictional record that is called a “representative record” and is constructed from older data in the initial receipt of with respect to the model. Also, the solver solves an optimization problem for this representative record in the solution, which will be close to all the solutions inside the data set. This is reported in FIG. 2 as a “representative solution” along with the Jacobian calculated around the solution.

The objective of the solution is that of finding a set of model parameters such that, when inputted in a model, the outputs of the model are as close as possible to the measurements obtained in the real gas turbine 111. Usually, this is achieved by solving the model equations, or by iterating parameters in the model until reaching the required convergence.

The records can be of several types, and in general include the ambient and operating conditions of the gas turbine 111, which are the so-called “inputs from records” or “degrees of freedom” of the model, namely the independent variables of the equation system, and they are indicated in the following with R. These inputs, together with the model parameters H of the gas turbine 111, produce system output parameters, or the dependent variables, which in the following are indicated with S. In the model, the system health (correct operation) is encoded via model parameters H. The model parameters H can include, just by way of example, efficiencies, flow capacities, discharge coefficients, etc.

As mentioned in general above, the general operation of the solver model, namely global search procedure 2, the system is based on has ideally two parts or main phases. In the first part, all the record inputs are entered in the model, using default model parameters (could be from design inputs, from previous model iterations, from engineering knowledge, etc.). These record inputs, together with the model, will generate simulated output parameters S′. The simulated output parameters S′ are compared with the actual system output parameters S, generating a set of residuals E as better explained below, for all input records R.

From these input parameter records R and residuals E, a representative record is generated as follows. A “representative input” is generated by averaging the inputs from all the records. This is not the only way to obtain a “representative input” set of parameters R*. Other ways include the median, or robust averaging techniques such as trimmed average, winsorized average, weighted average, among others. In the same way, a “representative residual” E* is obtained also by averaging the residuals E (or using the other methods already described). The representative outputs are then calculated as follows.

Preliminarily, the representative input R* to the model and default model parameters to obtain outputs P affect the outputs P by the “representative residuals” E*, to obtain “representative outputs” P*:

$${P}^{*} = P + {E}^{*} \qquad ( 1 )$$

The “representative record”, now consists of the representative inputs R* and the representative outputs P*.

In the present embodiment, it is synthesized only one representative record, but it is considered that the method is not limited to only one representative record.

In other embodiments, the synthesis of representative records can be extended to produce more than one representative record. This can be done if the solutions are not expected to be close to each other. In this case, the records may be separated using heuristics or clustering techniques such as k-means, and a representative record is obtained for each sub-population. In these cases, the global search procedure 2 and the local search procedure 3 can be performed for each representative record and subpopulation.

Continuing referring to FIG. 2, it is commented on and analyzed in detail. In step 21 records comprising the data from the gas turbine 111 are received in step 21. In step 23 only the input parameters R measured from the gas turbine 111 are selected and read, namely, their conditions concerning default values of the parameters are checked. These data are then processed in step 24 through a model function f, which constitutes the model of the system for determining the simulated values of the operation of the gas turbine 111. The model function f has as arguments the input measured parameters R and the model parameters H. At the same time, in step 22 the input parameters S measured but nonnecessary for defining the operation and the simulation of the gas turbine 111 are selected and read.

The output of the processing step 24 is that of a set of simulated outputs S′ of the gas turbine 111, which is received in step 25, which is then compared or differentiated with respect to the actual input parameters S read in step 22, as it can be seen looking at step 26. Then, after the comparison step 26, these differences, called residuals, E and variation for each parameter, derived by the comparison of the simulated output parameters S′ and the measured output parameters S, detected by the sensors of the gas turbine 111, are adjusted in the solver step 27, in order to determine the deviations or offsets of each simulated parameter over the actual parameter. At this point, these differences are feedback to the model parameter are step 28, for them to adjust the processing step 24. In other words, based on the difference matrix E obtained in processing step 26, the updated model parameters are read, in order to feed the processing in step 24. In addition, the model parameters obtained are reported in the reporting step 29 as the solution to the optimization problem with an acceptable comparison between, as mentioned above, the actual data obtained by the sensors of the gas turbine 111, and the simulated data by the simulating step 25 of the model.

As mentioned above, FIG. 2 is only a broad representation of the data flow. In the following figures, the operation of the data processing is deepened, providing more details about the actual processing of the set of data and parameters taken from gas turbine 111 and those simulated by the solver.

Referring now to FIG. 3, more processing details are provided. In particular, it is possible to see that the above-mentioned input records are constituted by a N×M matrix, where, as mentioned above, M is the number of sensed parameters, while N represents the number of records available (or timestamps). In particular, the parameters M are

$$M = R + S \qquad ( 2 )$$

where, R are the boundary conditions or input parameters, that determine the operating point of the gas turbine 111 to be monitored or simulated. In practice, R represent the records required to specify the operation of the gas turbine 111 to simulate. The remaining output records S are those operating variables that cannot be detected by sensors and cannot be then simulated. In general, the “inputs” matrix, referred to in steps 23 both in FIG. 2 and FIG. 3, is a N×R matrix. In this context, the output parameters S represent additional sensed and measured parameters in the system than those required to fully determine the operating point of the gas turbine 111.

The “system model” embedded in the processing step 24 (e.g., a black-box model or a machine learning-based model) is a function that can be described as

$$f ( r , h ) \qquad ( 3 )$$

where r is a vector of parameters that coincide with the input parameter matrix R and h is a matrix of model parameters, which, in the case at issue will be indicated with H. The model can also take matrices such as R and H, consisting of a multi-input setting to admit multiple inputs at the same time.

The system model in step 24, when entered matrices R and H, simulated output parameters S′. In the beginning, the simulated output parameters S′ are obtained from default model parameters H₀ or tuning factor of the model. The outputs simulated outputs S′ coincide (formally) with the outputs matrix S. The simulated outputs S′ are calculated by the processing step 24 obtaining the simulated outputs of the system 25. In comparison step 26 the residuals E are calculated. Specifically, the initial residuals for all records are calculated as follows

$$E = S - {S}^{′} \qquad ( 4 )$$

Then a so-called “representative point” of the system (gas turbine 111) operation is calculated, as better specified in the following. Then, an average of the residual matrix E is calculated, which can be a normal mean, a median, winsorized mean, etc. (a measure of location), which should be done for each one of the N “time”, therefore from a N×S set of parameters it is obtained a 1×S matrix called Eₘ.

Also, correspondingly, in step 262 an average, median, winsorized mean, etc. (a measure of location again) is calculated for the input matrix R to obtain a 1×R matrix Rₘ.

Then the representative point P time interval detection is calculated as

$$P = f ( {R}_{m} , {H}_{0} ) + {E}_{m} \qquad ( 5 )$$

To refer to the flowchart of FIG. 3, the application of the function f(·) is formally carried out in step 263, although from a substantial standpoint, the simulator run in step 263 is the same as that run in the system model step 24. As mentioned, H₀ are the initial model parameters, which can be derived from design or testing, and is a matrix of parameters. In other words, H₀ is just the initialization of the model parameters, also referred to as health parameters.

The representative point P is a single point (for each of the N moment of time), having the average residuals Eₘ representing a 1×S vector in the “space” of the parameters, calculated according to the above equation (5).

The solver at issue, such as genetic algorithm, gradient-based, trust region, etc., is then used to find a health parameter vector Hₘ such that

$$P = f ( {R}_{m} , {H}_{m} ) \qquad ( 6 )$$

where Hₘ is called the representative solution, capable of achieving the representative point P without the correction of the averaged residuals Eₘ, which turn out to be absorbed. This step is the solver step is the first solver step 27. The representative solution Hₘ is obtained by looping.

A Jacobian Jₘ is approximated for the matrix E with respect to the model parameters H and reported as a representative Jacobian, calculated in step 29. It represents, if we alter each health parameter in H, how will it impact the residual from each component in the S matrix.

Through the global search procedure 2 a partial solution as Hₘ, P and the Jacobian Jₘ is obtained around the representative solution Hₘ, calculated in an approximate way, for the matrix E over matrix H. As mentioned before, the local search procedure 3 is carried out, considering Hₘ and Jₘ, representing an approximate solution to all of the inputs of the system under analysis (the gas turbine 111).

The local search procedure 3 of the solver algorithm is illustrated in FIG. 4, and it's scope is that of refining the approximate solution given as mentioned by Hₘ and Jₘ, finding a so-called local search of the solution, as mentioned above.

In general, the local search procedure 3 starts from the representative solution obtained in the global search procedure 2. This representative solution should already be close to the real solution for every point, so the local search makes a linear update using the Jacobian Jₘ from the previous step until convergence, or an excessive number of iterations is reached for each point. The Jacobian does not need to be recalculated for every point, providing speed gains to the solver.

Then, referring to the mentioned FIG. 4, where, instead of starting with the model parameters at the beginning, the local search procedure 3 starts with the approximate solution Hₘ for all the model parameters. Likewise in FIG. 3, the same input parameters R (received in step 33) and output parameters S (received in step 32) are considered.

Therefore, considering the Jacobian matrix Jₘ, which is considered constant (not updated), after obtaining the residuals calculated in step 36, as in step 261 and the equation (3) above, namely E=S′−S, and the same solver step, now indicated with the reference number 37, is carried out to update the model parameters for all records using the representative Jacobian Jₘ. In particular, the following system of equations is executed

$$Δ H = {J}_{m}^{- 1} \cdot E \qquad ( 7 )$$

$${H}_{i + 1} = {H}_{i} + Δ H \qquad ( 8 )$$

In step 38 the representative solution is used Hₘ.

The corrected data are fed to the model parameter step 38, to start another iteration, calculating in step 34 a new set of simulated output parameters S always by the model function f(·), from which a new set of model parameters Hₘ. The inverted Jacobian Jₘ⁻¹ is a pseudo-inverted matrix, since to calculate it, one of the commonly available algebraical procedures is applied. Such procedures are well known in the art and are available in the literature for a skilled person.

In the first iteration, the local search procedure 3 starts with Hₘ and in any, there are still residuals E. Therefore, the solution is still an approximation and a refinement is required. In any case, at this stage of the simulation method, the available solution is still very close to the current one, and minor refinements are required. For this reason, it is sufficient to use as mentioned the constant Jacobian Jₘ obtained in the previous phase or procedure. The iterations for the refinement of the solution ends as soon as the residuals E is zero or reach values within a certain accepted tolerance or threshold, obtaining the refined model parameters H* which is the solution for all the points of the equation problem eventually obtained in reporting step 39. The solution of the problem can be represented by the following equation

$$S = f ( R , {H}^{*} ) \qquad ( 8 )$$

where, as mentioned above, R are the input parameters, namely the boundary conditions that determine the operating point of the gas turbine 111 to be monitored or simulated, while S are the output parameters of the sensed parameters not essential to obtain the operating point of the gas turbine, or the simulated and calculated variables, to characterizing the gas turbine 111.

The model parameters obtained and simulated H* cannot be usually measured, and couldn't be directly or indirectly monitored. Model parameters H have also a diagnostic value, so it's possible to detect possible issues I the gas turbine 111 through an analysis of said model parameters H, e.g. checking their variation along the time and comparing the slopes with a specific threshold to predict possible faults of a part or of the entire gas turbine 111.

In particular, still continuing with a diagnostic application the model parameters H* obtained through the simulation method described, such model parameters H* are a characterization of the gas turbine 111, as these parameters allow the models to coincide with (and therefore obtain) real data. However, the objective of characterizing the system may not be limited to just obtaining the model parameters H*, but also to “synthesize” or produce new parameters which may be useful for different stakeholders or users. These new parameters generated from the characterized model are called synthetic parameters.

One example of such synthetic parameters is the ISO Power at Full Load. This parameter corrects the power with respect to variations in operating and ambient conditions, thus constituting a parameter depending only on the true engine performance, which can be used either for performance tracking or for comparison among engines in the fleet.

Among the synthetic parameters that can be calculated used to assess the performance of the gas turbine 111 there are, in addition to the ISO Power, the ISO Heat Rate, Site Rated Power, Site Rated Heat Rate, etc. These parameters are designed to represent the health of the system over time independently of the ambient and operating conditions. This allows to give recommendations, detect anomalies and troubleshoot issues. The diagnostic parameters constituting the searched model parameters H can also be obtained for sub-systems, for example, each of the modules of the gas turbine 111. In some embodiments, there are diagnostic parameters (constituting the model parameters H), that concern only the health of the axial compressor, and diagnostic parameters that concern only the health of the High-Pressure Turbine. These parameters are called “modular health parameters”, and they help troubleshoot performance issues by signaling the degradation of each module.

Referring now to FIG. 5, it is illustrated a flowchart of how the simulated output parameters S′* are obtained. In particular, in the case at issue, considering the input parameters R, and now the model parameters, namely the health parameter H*, obtained by the simulation model above, it is obtained simulated outputs at reference conditions S′*, as

$${S}^{′ *} = f ( R , {H}^{*} ) \qquad ( 8 )$$

This simulation is obtained assimilated output specifically refined based on the specific status of the gas turbine 111. The simulated output parameters S′* is obtained from step 25 and can be stored in storing means for example the story means of the data recording unit 112, for further processing, such as, as mentioned, to calculate synthetic parameters.

As mentioned describing FIG. 1, the characterization system 1 comprises also the step of calculating non-measured (or measurable) parameters 133. In this case it is carried out an estimation of unmeasured quantities or virtual sensors. The gas turbine 111 may have quantities that are not measured but that have importance, for example, firing temperature, power output, fuel consumption, emissions, interstage pressures/temperatures, bleed pressures/temperatures, exhaust flow, among others. In this case, the refined model parameters H* are used together with the model function f(·) to simulate these unknown quantities, which may be byproducts of the simulations.

In other embodiments, virtual sensor redundancy/assessments is carried out. In this case, it is considered that, as mentioned above, the gas turbine 111 is be equipped with sensors that could be subject to failure. In this case, the model can be used to provide redundancy to existing sensors or to assess if these sensors have failed.

Referring to FIG. 6, an implementation of the embodiment is illustrated where the simulated output parameters S′* is then fed to a condition 1331, to check if each one of the variables or the parameters is already measured or not, in case not there will be the read as a virtual sensor in step 1332, while if positive, the reason sensor redundancy 1333. The data calculated will distort for further processing for example in to the storing means of the data recording unit 112.

The what-if scenario prediction is an enabler to provide new services based on data, including production optimization, emission minimization, maintenance optimization and can be an input to further process optimization schemes

The characterization outputs (i.e. map scalars) of the algorithm have fine-grained diagnostic value, as they can allocate performance losses to the specific modules, also enabling more targeted maintenances/corrective actions

While aspects of the invention have been described in terms of various specific embodiments, it will be apparent to those of ordinary skill in the art that many modifications, changes, and omissions are possible without departing form the spirt and scope of the claims. In addition, unless specified otherwise herein, the order or sequence of any process or method steps may be varied or re-sequenced according to alternative embodiments.

Reference has been made in detail to embodiments of the disclosure, one or more examples of which are illustrated in the drawings. Each example is provided by way of explanation of the disclosure, not limitation of the disclosure. In fact, it will be apparent to those skilled in the art that various modifications and variations can be made in the present disclosure without departing from the scope or spirit of the disclosure. Reference throughout the specification to “one embodiment” or “an embodiment” or “some embodiments” means that the particular feature, structure or characteristic described in connection with an embodiment is included in at least one embodiment of the subject matter disclosed. Thus, the appearance of the phrase “in one embodiment” or “in an embodiment” or “in some embodiments” in various places throughout the specification is not necessarily referring to the same embodiment(s). Further, the particular features, structures or characteristics may be combined in any suitable manner in one or more embodiments.

When elements of various embodiments are introduced, the articles “a”, “an”, “the”, and “said” are intended to mean that there are one or more of the elements. The terms “comprising”, “including”, and “having” are intended to be inclusive and mean that there may be additional elements other than the listed elements.

1. A simulation method for simulating the operation of an engine, such as a gas turbine, wherein the engine comprises a plurality of sensors to sense a corresponding plurality of data, representing the measured input parameters, wherein the measured input parameters comprise input parameter records for defining the operation of the engine, and output parameters, wherein the method comprises the steps of:
A. carrying out a global search procedure, for determining the solution of the model parameters, whereby the operation of the engine can be simulated;
B. carrying out a local search procedure, for calculating refined model parameters for simulating the operation of the engine;
C. simulating the output parameters based on the refined model parameters and the input parameters, for checking the operation of the engine; and
D. using the output parameters to derive data and/or unmeasured or unmeasurable parameters of the engine.

2. The method of claim 1, wherein the global search procedure comprises the following steps:
A1. receiving the data representing the measured parameters from the gas turbine;
A2. selecting from the measured parameter records of the gas turbine the input parameter records;
A3. receiving the model parameters default model parameters;
A4. processing by a functioning model f(·) of the engine the input parameters and obtained from default model parameters to obtain simulated output parameters of the engine;
A5. receiving the simulated output parameters of the engine;
A6. selecting the output parameter records, as the other measured parameters received from the engine;
A7. calculating residuals as difference of the simulated output parameters and the output parameters;
A8. determining representative residual parameters of the residuals, and a representative input parameter of the input parameters;
A9. determining a representative point based on the representative residual parameters, the representative input parameter, and the default model parameters; and
A10. solving the optimization problem to obtain the representative solution of the model parameters, capable of achieving the representative point without the correction of the averaged residuals.

3. The method of claim 1, wherein the local search procedure comprises the following steps:
B1. receiving the data representing the measured parameters from the gas turbine;
B2. selecting from the measured parameter records of the gas turbine the input parameter records;
B3. processing by a functioning model f(·) of the engine the input parameters and the representative solution of the model parameters to obtain simulated output parameters of the engine;
B4. calculating residuals as the difference of the simulated output parameters obtained by the solution of the model parameters, and the output parameters; and
B5. calculating a new set of model parameters based on the residuals obtained in the previous calculating step;
iteratively repeating the steps B3-B5 to obtain the refined model parameters to simulate the operation of the engine.

4. The method of claim 3,
wherein the global search procedure comprises the step of calculating a Jacobian approximated for the residuals with respect to the model parameters as a representative Jacobian, and
wherein the local search procedure comprises the step of calculating a new set of model parameters based on the residuals obtained in the previous calculating step is also based on the Jacobian.

5. The method of claim 4, wherein the step of calculating refined model parameters is carried out iterating according to the following equations:
$$Δ H = {J}_{m}^{- 1} \cdot E$$
$${H}_{i + 1} = {H}_{i} + Δ H$$
up to the obtainment of the refined model parameters, where Jₘ⁻¹ is the inverted Jacobian.

6. The method of claim 2, wherein the step of determining a representative residual is calculated by average, median, winsorized mean.

7. The method of claim 2, wherein the step of determining a representative point is carried out according to the following equation
$$P = f ( {R}_{m} , {H}_{0} ) + {E}_{m}$$
where the function f(·) is the functioning model of the engine.

8. The method of claim 2, wherein the optimization problem is based on a genetic algorithm, a gradient-based, a trust region, and/or the like.

9. The method of claim 1, wherein the step of using the output parameters comprises the sub-step of:
calculating synthetic parameters to characterize the engine with respect to parameters of the ambient in which the engine operates, to detect anomalies and manage to troubleshoot issues; and
storing the synthetic parameters.

10. The method of claim 9, wherein the synthetic parameters comprise the ISO Power at Full Load, the ISO Heat Rate, Site Rated Power, and/or Site Rated Heat Rate.

11. The method of claim 1, wherein the step of using the output parameters comprises the sub-step of:
carrying out virtual sensor redundancy/assessments, by estimating unmeasured quantities or virtual sensors, wherein the refined model parameters are used with the model function f(·) to simulate unknown parameters to determine the outcome of a virtual sensor or to have the parameter measured by a real sensor of the engine, so as to have a sensor redundancy, to check the operation of the real sensor.

12. The method of claim 1, wherein the data are detected along with a time interval in which a number of N data are gathered for each one of the measured input parameters.

13. A characterization system, for characterizing and simulating the operation of a gas turbine, comprising:
an infrastructure section, having:
a gas turbine to be controlled, having a plurality of sensors to detect a plurality of parameters that are sensed at different time intervals, and
a data recording unit, connected to the sensors of the gas turbine, configured to collect the data and the signals detected by the sensors; and
a processing unit, having
an automatic performance characterization section, comprising
a physics-based model, configured to carry the simulation method for simulating the operation of an engine, such as a gas turbine, by simulating the output parameters based on refined model parameters and input parameters from the sensors of the engine, for checking the operation of the engine, wherein the engine comprises a plurality of sensors to sense a corresponding plurality of data, representing the measured input parameters, wherein the measured input parameters comprise input parameter records for defining the operation of the engine, and output parameters, and wherein the method comprises the steps of:
A. carrying out a global search procedure, for determining the solution of the model parameters, whereby the operation of the engine can be simulated;
B. carrying out a local search procedure, for calculating refined model parameters for simulating the operation of the engine;
C. simulating the output parameters based on the refined model parameters and the input parameters, for checking the operation of the engine; and
D. using the output parameters to derive data and/or unmeasured or unmeasurable parameters of the engine; and
a delivery service section, for using the output parameters to derive data and/or unmeasured or unmeasurable parameters of the engine.

14. The system of claim 13, wherein the automatic performance characterization section comprises an automatic data processing module, configured to correct possible corruptions of the data taken from the sensors of the gas turbine.

15. The system of claim 13, wherein the delivery service section comprises:
a calculation of corrected parameters module to detect the degradation of the engine performances;
a non-measurable parameters calculator module; and
a module for tracking the trend and monitoring of the modular parameters.

16. The system of claim 13, wherein optimizations procedures such as maintenance optimization to improve engine performance, reliability, availability, emissions, calculation of key performance indicators using the outputs of the physics-based model.
